(19) United States
(12) Patent Application Publication
(10) Pub. No.: US 2022/0270818 A1
(43) Pub. Date: Aug. 25, 2022

(54) METHOD FOR PREPARING HIGH-PERFORMANCE SOFT MAGNETIC COMPOSITE AND MAGNETIC TOROIDAL CORE THEREOF

(71) Applicant: CHINA JILIANG UNIVERSITY, Hangzhou, Zhejiang (CN)

(72) Inventors: Xiaoling Peng, Hangzhou, Zhejiang (CN); Jing Li, Hangzhou, Zhejiang (CN); Xinqing Wang, Hangzhou, Zhejiang (CN); Hongliang Ge, Hangzhou, Zhejiang (CN); Yanting Yang, Hangzhou, Zhejiang (CN); Jingcai Xu, Hangzhou, Zhejiang (CN); Hongxiao Jin, Hangzhou, Zhejiang (CN); Dingfeng Jin, Hangzhou, Zhejiang (CN); Bo Hong, Hangzhou, Zhejiang (CN)

(73) Assignee: CHINA JILIANG UNIVERSITY, Hangzhou, Zhejiang (CN)

(21) Appl. No.: 17/627,141

(22) PCT Filed: May 29, 2020
(86) PCT No.: PCT/CN20/93243

§ 371 Date: Jan. 14, 2022

(30) Foreign Application Priority Data
Nov. 28, 2019 (CN) 201911188794.8

(51) Int. Cl. H01F 41/02; H01F 1/147; H01F 27/255; B22F 3/24; B22F 3/02; B22F 1/05

(52) U.S. Cl. CPC H01F 41/0246; H01F 1/147; H01F 27/255; B22F 3/24; B22F 3/02; B22F 1/05; B22F 2003/248; B22F 2304/10; B22F 2301/35

(57) ABSTRACT

Disclosed are methods for preparing a high-performance soft magnetic composites and magnetic toroidal cores thereof. A spherical soft magnetic alloy particle is coated with an insulating layer to form a mixed powder, and the mixed powder is loaded into a mold and subjected to a compression molding. An external magnetic field is applied during the compression molding of the mixed powder, and the external magnetic field is parallel to a working magnetic circuit plane and perpendicular to a normal direction of the working magnetic circuit plane. Then a stress-relief annealing is performed to obtain the high-performance soft magnetic composite.

### CROSS REFERENCE TO RELATED APPLICATIONS

The present application is a U.S. national stage application of PCT International Application No. PCT/CN2020/093243, filed May 29, 2020 and published as PCT Publication WO/2021/103,467 on Jun. 3, 2021, which claims priority to Chinese Patent Application No. 201911188794.8 filed on Nov. 28, 2019. The disclosures of all of the foregoing applications are hereby incorporated by reference in their entirety into the present application.

### TECHNICAL FIELD

The present disclosure relates to the preparation of magnetic materials, and specifically relates to a method for preparing a high-performance soft magnetic composite and a magnetic toroidal core thereof.

### BACKGROUND ART

There is a kind of soft magnetic composite with high magnetic flux and low loss, which is also called magnetic powder core in the industrial field. The resistivity of the soft magnetic composite is higher than that of the metal soft magnetic material, and thereby the core loss thereof is lower. The saturation magnetization of the soft magnetic composite is higher than that of ferrite, and thereby the power density thereof is higher. Thus, the soft magnetic composite has unique advantages and application scope.

The soft magnetic composite is formed by coating a magnetic particle with an insulating layer (organic material, inorganic material insulating layer) to obtain a mixed powder, and forming the mixed powder into an isotropic bulk material by using a powder metallurgy technology. The existing soft magnetic composites that are made by the industrial production are isotropic, which means that the magnetic properties are the same in all directions. However, in practical applications, the magnetic property in the direction of the working magnetic circuit is the only direction of interest, and the magnetic property in the direction of the non-working magnetic circuit will not affect the working characteristics of the soft magnetic composite. Therefore, the isotropic property actually causes the waste of the magnetic property of the soft magnetic composite. To increase the permeability, the thickness of the non-magnetic insulating layer can be reduced, but it results in reduced resistivity and increased eddy current loss. To reduce the loss, the resistivity of the soft magnetic alloy and the thickness of the insulating layer can be increased, whereas the conductivity and the saturation magnetization would be decreased. Therefore, it is difficult for the isotropic soft magnetic composites to meet the requirements on high permeability, high saturation magnetization, and low loss at the same time. The improvement of one property usually causes the decrease of other properties.

However, the technical solutions used in conventional applications to increase the permeability or reduce the loss usually involve improving the properties in all directions at the same time, which to a certain extent causes the waste of the magnetic property in the direction of the non-working magnetic circuit.

### SUMMARY

The following summary is provided to introduce a selection of concepts in a simplified form that are further described below in the detailed description. This summary is not intended to identify key features or essential features of the claimed subject matter, nor is it intended to be used to limit the scope of the claimed subject matter.

In various implementations, a method for preparing a high-performance soft magnetic composite, comprising coating a spherical soft magnetic alloy particle with an insulating layer to form a mixed powder, loading the mixed powder into a mold, and subjecting the mixed powder to a compression molding is provided. An external magnetic field is applied during the compression molding of the mixed powder. The external magnetic field is parallel to a working magnetic circuit plane and perpendicular to a normal direction of the working magnetic circuit plane; and performing a stress-relief annealing to obtain the high-performance soft magnetic composite.

The soft magnetic composite is prepared without orientation induced by the external magnetic field, the spherical soft magnetic alloy particle used is uniform in all directions due to its spherical shape, and thus the resistivity, permeability, loss, and magnetic reluctance are also isotropic.

In some implementations, a magnetic field parallel to the working magnetic circuit plane is creatively applied during compression molding for the preparation of the composite, which realizes the rearrangement of a magnetic phase and a non-magnetic phase, thereby obtaining a soft magnetic composite with an unexpected better property. The non-magnetic phase of the insulating layer of the composite is distributed asymmetrically around the spherical magnetic phase. Specifically, the spherical soft magnetic alloy particle is arranged closely and orderly along a direction of a magnetic toroidal core plane (mark as horizontal plane), so that a non-magnetic particle is pushed and repelled by the spherical soft magnetic alloy particle to distribute continuously, and the spherical soft magnetic alloy particle is arranged in a disordered manner in a normal direction of the magnetic toroidal core, so that the non-magnetic particle is arranged discontinuously. Therefore, the resistivity, permeability, loss, and magnetic reluctance of the soft magnetic composite are anisotropic. Along the direction of the external magnetic field, the magnetic reluctance, demagnetizing field and hysteresis loss are decreased, and the permeability is increased. On the other hand, in the composite obtained by orientation paralleling the direction of the external magnetic field, the magnetic particles with small size fill in the horizontal gaps better, so that gaps in the horizontal direction are reduced, thereby further reducing the magnetic reluctance, and increasing the permeability.

When the mixed powder is compression-molded into a magnetic toroidal core and the magnetic toroidal core works, its working magnetic circuit is a closed loop along the circumference of the magnetic toroidal core. The correspondingly generated eddy current is completely perpendicular to the circumference of the magnetic toroidal core, which corresponds to the eddy current loss in the direction parallel to the axial direction, and the eddy current loss along the direction of the magnetic field is reduced. Therefore, the soft magnetic composite exhibits good soft magnetic properties.

In some embodiments, the external magnetic field has an intensity of 0.1-10 T.

In some embodiments, the external magnetic field is one selected from the group consisting of a coil magnetic field, an electromagnet magnetic field, and a pulsed magnetic field.

In some embodiments, the external magnetic field is applied in a whole process for the compression molding of the mixed powder.

In some embodiments, a mass fraction of the spherical soft magnetic alloy particle is in the range of about 90 wt %-about 99.9 wt %, and a mass fraction of the insulating layer is in the range of about 0.1 wt %-about 10 wt %.

In some embodiments, the spherical soft magnetic alloy particle is one selected from the group consisting of Fe particle, Fe—Si particle, Fe—Ni particle, Fe—Ni—Mo particle, Fe—Si—Al particle, Fe—Si—B amorphous particle, and Fe-based nanocrystalline alloy particle.

In some embodiments, the insulating layer is one selected from the group consisting of glass powder, sodium silicate, MgO, SiO₂, Al₂O₃, ZnO, and TiO₂. A mixture of several insulating layer powder as mentioned above can be used as an insulating layer to coat the spherical soft magnetic alloy particles.

In some embodiments, the spherical soft magnetic alloy particle has a particle size of about 5 μm-about 40 μm, and the non-magnetic particle has a diameter of about 10 nm-about 200 nm. The diameter of the non-magnetic particle is much smaller than that of the spherical soft magnetic alloy particle, to achieve a good coating effect.

In some embodiments, the spherical soft magnetic alloy particle is prepared by a gas atomization method or a water atomization method.

Another object of the present disclosure is to provide a magnetic toroidal core containing the high-performance soft magnetic composite, which can be widely used in devices such as motors, low-frequency to high-frequency transformers, sensors, chokes, noise filters, and fuel injectors.

The magnetic toroidal core containing the high-performance soft magnetic composite includes a magnetic toroidal core body, and the magnetic toroidal core body comprises the spherical soft magnetic alloy particle and the non-magnetic particle. The spherical soft magnetic alloy particle is coated with the non-magnetic particle. The non-magnetic particle is distributed at the interface between the spherical soft magnetic alloy particles: the spherical soft magnetic alloy particle is arranged closely and orderly along the direction of the magnetic toroidal core plane, so that the non-magnetic particle is pushed and repelled by the spherical soft magnetic alloy particle to distribute continuously; the spherical soft magnetic alloy particle is arranged in a disordered manner in the normal direction of the magnetic toroidal core, so that the non-magnetic particle is arranged discontinuously. The anisotropic distribution of the spherical soft magnetic alloy particle causes the anisotropic distribution of the non-magnetic particle in the magnetic toroidal core.

Compared with the uniform distributions of the soft magnetic alloy particle and the non-magnetic phase, the anisotropic structure of the magnetic toroidal core in the present disclosure has higher permeability and lower loss.

The present disclosure has the following technical effects:

1. The technical solutions according to the present disclosure are simple, and make it possible to achieve high performance without strict requirements on magnetic powder and equipment.

2. The non-magnetic phase is distributed asymmetrically: the non-magnetic phase is distributed in the continuous chain-like manner along the direction of the magnetic field, and thereby the magnetic reluctance and loss of the horizontal magnetic circuit are reduced. The magnetic phase is distributed asymmetrically: the magnetic phase is distributed tightly and orderly along the direction of the magnetic field, and the air gaps in the direction of the magnetic toroidal core plane are preferentially filled with the magnetic particle with small size, so the magnetic reluctance and loss of the horizontal magnetic circuit are reduced.

3. The soft magnetic composite obtained through the orientation paralleling to the working magnetic circuit plane exhibits high permeability and low loss.

4. Through the technical solutions according to the present disclosure, it is possible to achieve, quickly, the industrial application of the soft magnetic composite with less equipment and simple process including less steps.

### BRIEF DESCRIPTION OF THE DRAWINGS

The accompanying drawings as part of the present disclosure are used to provide a further understanding of the present disclosure, and the exemplary examples and their descriptions are used to illustrate the present disclosure, not to limit the present disclosure improperly.

FIG. 1 shows a scanning electron microscopy image of a sample after being coated in the manner described in Example 1.

FIG. 2 shows a scanning electron microscope image of a sample obtained with orientation induced by a horizontal magnetic field in Example 1, with the magnetic field in a horizontal direction.

FIG. 3 shows a scanning electron microscope image (as a comparison) of a sample obtained without orientation induced by a magnetic field (not applying magnetic field) in Example 1.

FIG. 4 shows effective permeability of the sample in Example 1.

FIG. 5 shows core loss of the sample in Example 1.

FIG. 6 shows a real part of complex permeability of the sample in Example 1.

FIG. 7 shows an imaginary part of the complex permeability of the sample in Example 1.

FIG. 8 shows a quality factor of the sample in Example 1.

FIG. 9 shows loss tangent of the sample in Example 1.

FIG. 10 shows a μQ product of the sample in Example 1.

FIG. 11 is a schematic diagram of a high-performance soft magnetic composite of the present disclosure.

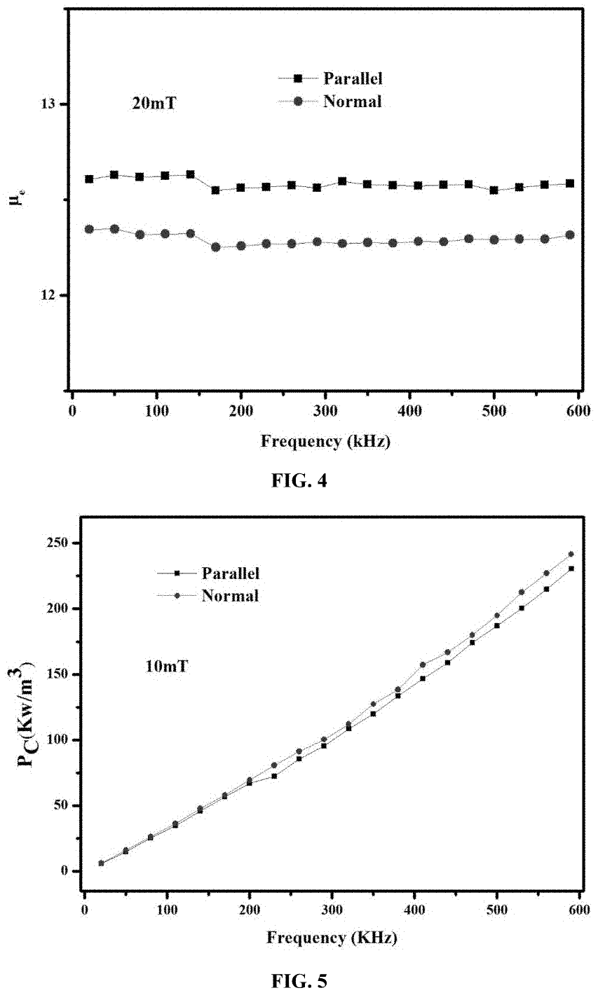

In FIGS. 4-10, Normal represents the curve of the sample obtained without orientation induced by the external magnetic field, and Parallel represents the curve of the sample with the orientation induced by the external magnetic field.

In FIG. 11, 1 represents a spherical soft magnetic alloy particle, and 2 represents a non-magnetic particle.

### DETAILED DESCRIPTION OF THE EMBODIMENTS

The present disclosure will be described in detail with reference to the accompanying drawings and specific examples. The exemplary examples and their descriptions are only used to illustrate the present disclosure, not intended to limit the present disclosure improperly.

It shall be noted that the examples and their features in the present disclosure can be combined with each other without conflict. Hereinafter, the present disclosure will be described in detail with reference to the accompanying drawings and examples.

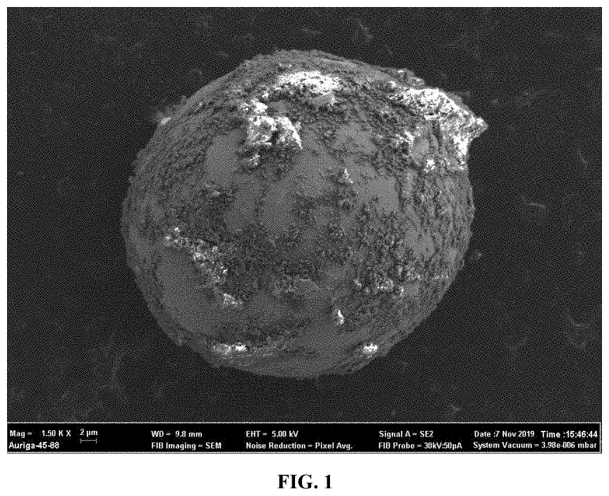

As shown in FIGS. 1 and 11, FIG. 1 shows the schematic diagram of a single spherical soft magnetic alloy particle coated by the non-magnetic phase (i.e. the insulating layer), and FIG. 11 shows the schematic cross-sectional view of the soft magnetic composite in an ideal state assuming that the spherical soft magnetic alloy particles are the same and the non-magnetic particles are the same.

The following examples will take the common toroidal core as examples. The soft magnetic composite in other shapes has the same properties which will not be repeated here.

### EXAMPLE 1

### 1) Preparation of Raw Materials

The main magnetic phase was the spherical Fe—Si—B amorphous soft magnetic alloy particle with an average diameter of 20 μm, obtained by a gas atomization method. The non-magnetic phase of the insulating layer was Al₂O₃ powder with an average diameter of 90 nm, as the interface phase between the spherical Fe—Si—B amorphous soft magnetic alloy particles.

### 2) Coating the Soft Magnetic Alloy Particle with an Insulating Layer

The spherical amorphous Fe—Si—B soft magnetic alloy particles were passivated and then fully mixed with Al₂O₃ powder, to coat the spherical Fe—Si—B amorphous soft magnetic alloy particle with the Al₂O₃ powder and form an Al₂O₃ insulating layer, obtaining a mixed powder (in which, the mass fraction of the spherical Fe—Si—B amorphous soft magnetic alloy particle was 96 wt %, and the mass fraction of the Al₂O₃ powder was 4 wt %). The coating effect was shown in FIG. 1.

### 3) Molding with an Orientation by Applying a Magnetic Field

The mixed powder obtained in step 2) was loaded into a toroidal mold and subjected to a compression molding, and an electromagnet magnetic field was applied during the compression molding of the magnetic toroidal core. The magnetic field was parallel to the magnetic toroidal core plane (the working magnetic circuit plane) and perpendicular to the normal direction of the magnetic toroidal core (the normal direction of the working magnetic circuit plane). The magnetic field intensity was 1 T, to re-arrange the main magnetic phase (the spherical Fe—Si—B amorphous soft magnetic alloy particle) and the non-magnetic phase (the Al₂O₃ powder) in the magnetic toroidal core.

### 4) Performing a Stress-Relief Annealing

After the toroidal soft magnetic composite (the magnetic toroidal core) was molded, a stress-relief annealing was further performed to reduce the hysteresis loss, obtaining the high-performance soft magnetic composite with the anisotropic distributions of both the soft magnetic alloy particle and the non-magnetic phase.

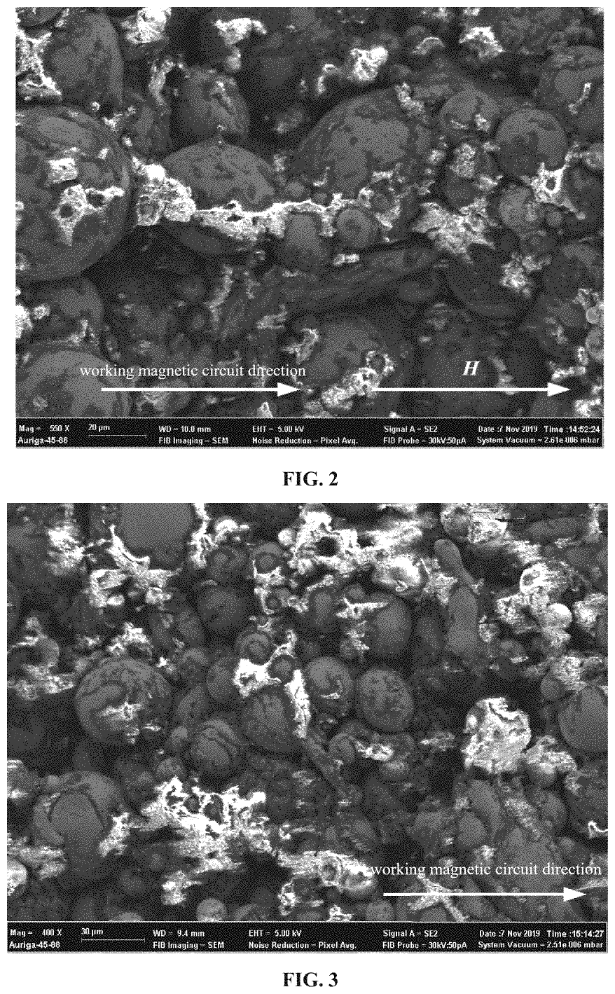

FIG. 2 shows the scanning electron microscope image of the sample obtained by applying a magnetic field parallel to the magnetic toroidal core plane (the working magnetic circuit plane). It can be seen that the magnetic powder is continuously distributed in the horizontal direction, some of the magnetic powder forms a chain, and that the magnetic powder with smaller size fills in the horizontal gaps. In addition, a good continuous distribution of the Al₂O₃ powder is formed in the direction of the magnetic field due to the repulsive force of the magnetic particle.

FIG. 3 shows the scanning electron microscope image of the sample without orientation induced by the magnetic field (as the comparison). It can be seen that the magnetic powder and the insulating medium are basically evenly distributed.

FIG. 4 shows the effective permeability of the samples in FIG. 2 and FIG. 3. It can be seen that the sample with orientation induced by the horizontal magnetic field has higher permeability.

FIG. 5 shows the core loss of the samples in FIG. 2 and FIG. 3. It can be seen that the sample with orientation induced with the horizontal magnetic field has a lower loss.

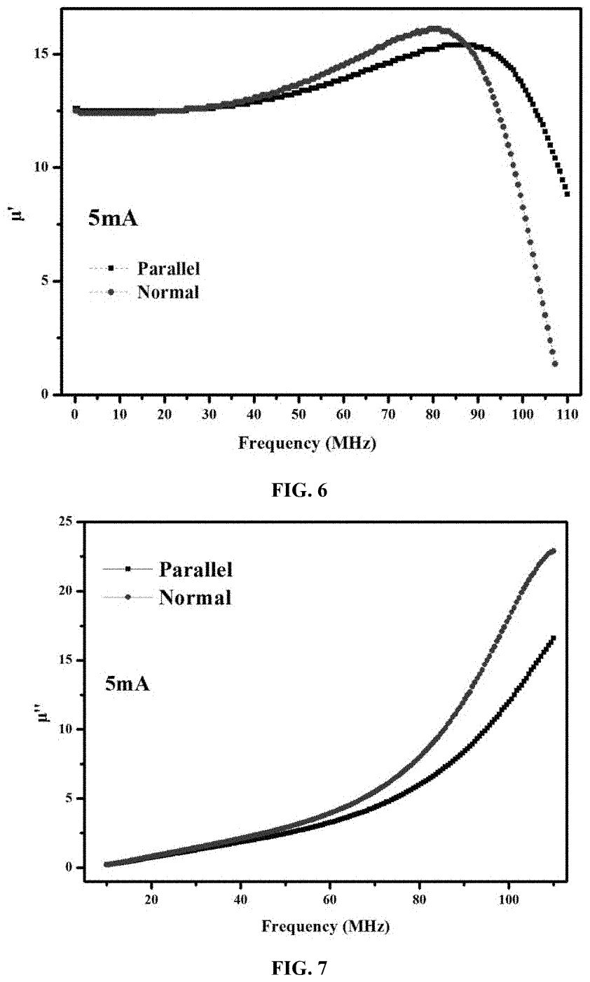

FIG. 6 shows the real part of the complex permeability of the samples in FIG. 2 and FIG. 3. It can be seen that the sample with orientation induced by the horizontal magnetic field has higher permeability at low frequency and higher cut-off frequency.

FIG. 7 shows the imaginary part of the complex permeability of the samples in FIG. 2 and FIG. 3. It can be seen that the sample with the orientation induced by the horizontal magnetic field has a significantly lower loss, especially even lower at high frequency.

FIG. 8 shows the quality factor of the samples in FIG. 2 and FIG. 3. It can be seen that the sample with orientation induced by the horizontal magnetic field has a higher quality factor.

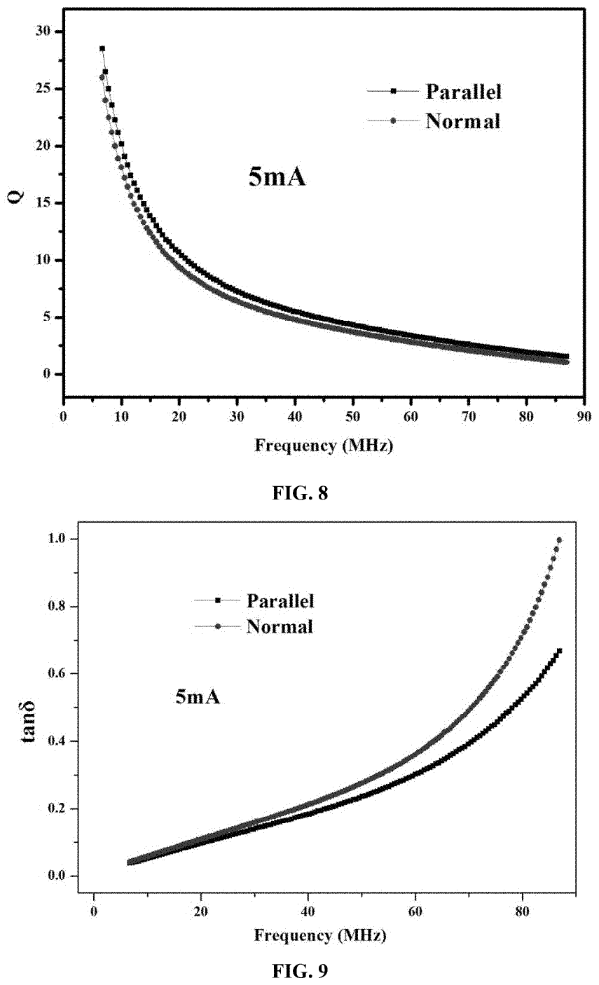

FIG. 9 shows the loss tangent of the samples in FIG. 2 and FIG. 3. It can be seen that the sample with orientation induced by the horizontal magnetic field has a smaller loss tangent, that is, the loss is lower.

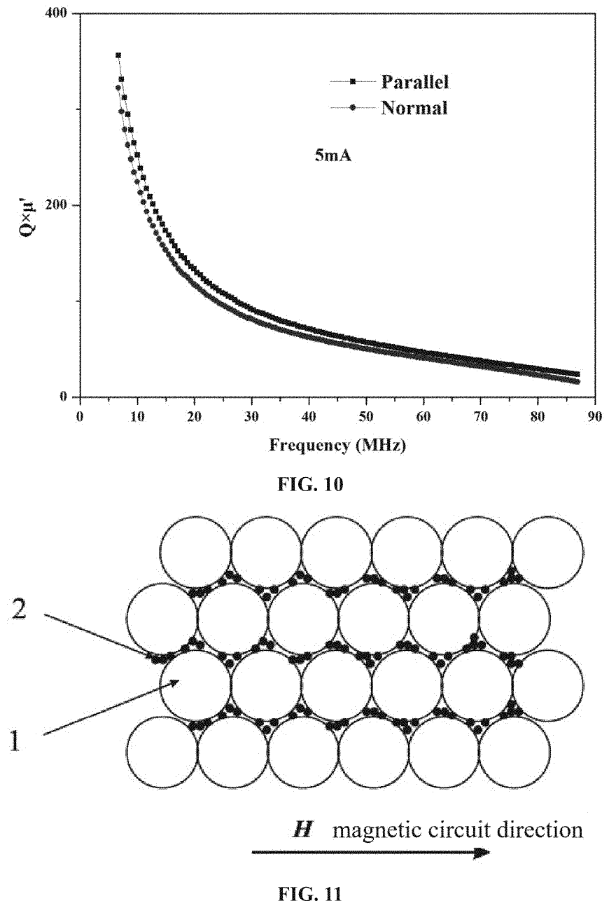

FIG. 10 shows the μQ product of the samples in FIG. 2 and FIG. 3. It can be seen that the sample with orientation induced by the horizontal magnetic field has a higher μQ product, and exhibits better comprehensive soft magnetic properties.

Therefore, it can be seen that by applying the magnetic field parallel to the working magnetic circuit plane to orient the sample during the preparation process, excellent comprehensive soft magnetic properties could be achieved.

### EXAMPLE 2

### 1) Preparation of Raw Materials

The main magnetic phase was the spherical Fe soft magnetic alloy particle obtained by a water atomization method. The non-magnetic phase of the insulating layer was the glass powder, as the interface phase between the spherical Fe soft magnetic alloy particles.

### 2) Coating the Soft Magnetic Alloy Particle with an Insulating Layer

The spherical Fe soft magnetic alloy particles were passivated and then fully mixed with glass powder, obtaining a mixed powder. In the mixed powder, the spherical Fe soft magnetic alloy particles were coated with the glass powder, forming an insulating layer, and the mass fraction of Fe was 90 wt %, and the mass fraction of the glass powder was 10 wt %.

### 3) Molding with an Orientation by Applying a Magnetic Field

The mixed powder obtained in step 2) was loaded into a toroidal mold and subjected to a compression molding, and a coil magnetic field was applied during the compression molding of the magnetic toroidal core. The magnetic field was parallel to the magnetic toroidal core plane (the working magnetic circuit plane) and perpendicular to the normal direction of the magnetic toroidal core (the normal direction of the working magnetic circuit plane). The magnetic field intensity was 0.1 T, to re-arrange the soft magnetic alloy particle and the non-magnetic phase in the magnetic toroidal core.

### 4) Performing a Stress-Relief Annealing

After the soft magnetic composite magnetic toroidal core was molded, a stress-relief annealing was further performed to reduce the hysteresis loss, obtaining the high-performance soft magnetic composite with the non-uniform distributions of the main magnetic phase (the spherical Fe soft magnetic alloy particle) and the non-magnetic phase (the glass powder).

Table 1 shows the effective permeability and loss of the glass powder/Fe soft magnetic composite with and without orientation induced by the magnetic field.

TABLE 1

| | Testing | Effective | |
|---|---|---|---|
| | frequency | permeability (μe) | Loss (kW/m³) |
| The glass | 50 kHz | 18.8 | 31 |
| powder/Fe soft | 200 kHz | 18.6 | 133 |
| magnetic composite | 400 kHz | 18.3 | 272 |
| induced by the | 600 kHz | 18.1 | 467 |
| with orientation | | | |
| horizontal magnetic | | | |
| field | | | |
| The glass | 50 kHz | 17.2 | 35 |
| powder/Fe soft | 200 kHz | 17.1 | 149 |
| magnetic composite | 400 kHz | 16.9 | 297 |
| without orientation | 600 kHz | 16.5 | 501 |
| induced by the | | | |
| magnetic field | | | |

It can be seen that the glass powder/Fe soft magnetic composite with the orientation induced by the magnetic field parallel to the working magnetic circuit plane has high permeability and low loss.

### EXAMPLE 3

### 1) Preparation of Raw Materials

The main magnetic phase was the spherical Fe—Si soft magnetic alloy particle obtained by a gas atomization method, and the interface phase was the non-magnetic phase of sodium silicate.

### 2) Coating the Soft Magnetic Alloy Particle with an Insulating Layer

The spherical Fe—Si soft magnetic alloy particle was passivated and then fully mixed with sodium silicate, obtaining a mixed powder. The spherical Fe—Si soft magnetic alloy particles were coated with sodium silicate, forming an insulating layer. In the mixed powder, the mass fraction of Fe—Si was 92 wt %, and the mass fraction of sodium silicate was 8 wt %.

### 3) Molding with an Orientation by Applying a Magnetic Field

The mixed powder obtained in step 2) was loaded into a toroidal mold and subjected to a compression molding, and an electromagnetic magnetic field was applied during the compression molding of the magnetic toroidal core. The magnetic field was parallel to the magnetic toroidal core plane (the working magnetic circuit plane) and perpendicular to the normal direction of the magnetic toroidal core (the normal direction of the working magnetic circuit plane). The magnetic field intensity was 0.4 T, to re-arrange the main magnetic phase (the spherical Fe—Si soft magnetic alloy particle) and the non-magnetic phase (sodium silicate) in the magnetic toroidal core.

### 4) Performing a Stress-Relief Annealing

After the soft magnetic composite magnetic toroidal core was molded, a stress-relief annealing was further performed to reduce the hysteresis loss, obtaining the high-performance soft magnetic composite with the non-uniform distributions of the soft magnetic alloy particle and the non-magnetic phase.

Table 2 shows the effective permeability and loss of sodium silicate/Fe—Si soft magnetic composite with and without orientation induced by the magnetic field.

TABLE 2

| | Testing | Effective | |
|---|---|---|---|
| | frequency | permeability (μe) | Loss (kW/m³) |
| The sodium | 50 kHz | 17.4 | 26 |
| silicate/Fe—Si soft | 200 kHz | 17.3 | 107 |
| magnetic composite | 400 kHz | 17.1 | 219 |
| with orientation | 600 kHz | 16.9 | 376 |
| induced by the | | | |
| horizontal magnetic | | | |
| field | | | |
| The sodium | 50 kHz | 15.8 | 31 |
| silicate/Fe—Si soft | 200 kHz | 15.8 | 122 |
| magnetic composite | 400 kHz | 15.2 | 245 |
| without orientation | 600 kHz | 14.9 | 413 |
| induced by the | | | |
| magnetic field | | | |

It can be seen that sodium silicate/Fe-Si soft magnetic composite with the orientation induced by the magnetic field parallel to the working magnetic circuit plane has high permeability and low loss.

### EXAMPLE 4

### 1) Preparation of Raw Materials

The spherical Fe—Ni soft magnetic alloy particle obtained by a water atomization method was used as the main magnetic phase, and the interface phase was the non-magnetic phase of MgO powder.

### 2) Coating the Soft Magnetic Alloy Particle with an Insulating Layer

The spherical Fe—Ni soft magnetic alloy particle was passivated and then fully mixed with a MgO powder, forming a mixed powder. The spherical Fe—Ni soft magnetic alloy particles were coated with the MgO powder, forming an insulating layer. In the mixed powder, the mass fraction of the spherical Fe—Ni soft magnetic alloy particle was 95 wt %, and the mass fraction of the MgO powder was 5 wt %.

### 3) Molding with an Orientation by Applying a Magnetic Field

The mixed powder obtained in step 2) was loaded into a toroidal mold and subjected to a compression molding, and an electromagnetic magnetic field was applied during the compression molding of the magnetic toroidal core. The magnetic field was parallel to the magnetic toroidal core plane (the working magnetic circuit plane) and perpendicular to the normal direction of the magnetic toroidal core (the normal direction of the working magnetic circuit plane). The magnetic field intensity was 0.6 T, to re-arrange the main magnetic phase (the spherical Fe-Ni soft magnetic alloy particle) and the non-magnetic phase (the MgO powder) in the magnetic toroidal core.

### 4) Performing a Stress-Relief Annealing

After the soft magnetic composite magnetic toroidal core was molded, a stress-relief annealing was further performed to reduce the hysteresis loss, obtaining the high-performance soft magnetic composite with the non-uniform distributions of the soft magnetic alloy particle and the non-magnetic phase.

After testing, the sample with the orientation induced by the magnetic field parallel to the working magnetic circuit plane has excellent comprehensive soft magnetic properties.

### EXAMPLE 5

### 1) Preparation of Raw Materials

The spherical Fe—Ni—Mo soft magnetic alloy particle obtained by a water atomization method was used as the main magnetic phase, and SiO₂ powder was used as the non-magnetic phase, as the interface phase between the spherical Fe—Ni—Mo soft magnetic alloy particles.

### 2) Coating the Soft Magnetic Alloy Particle with an Insulating Layer

The spherical Fe—Ni—Mo soft magnetic alloy particle was passivated and then fully mixed with a SiO₂ powder, forming a mixed powder. The spherical Fe—Ni—Mo soft magnetic alloy particles were coated with the SiO₂ powder, forming an insulating layer outside the spherical Fe—Ni—Mo soft magnetic alloy particle. In the mixed powder, the mass fraction of the spherical Fe—Ni—Mo soft magnetic alloy particle was 97 wt %, and the mass fraction of the SiO₂ powder was 3 wt %.

### 3) Molding with an Orientation by Applying a Magnetic Field

The mixed powder obtained in step 2) was loaded into a toroidal mold and subjected to a compression molding to form a magnetic toroidal core, and an electromagnetic magnetic field was applied during the compression molding of the magnetic toroidal core. The magnetic field was parallel to the magnetic toroidal core plane (the working magnetic circuit plane) and perpendicular to the normal direction of the magnetic toroidal core (the normal direction of the working magnetic circuit plane). The magnetic field intensity was 0.8 T, to re-arrange the main magnetic phase (the spherical Fe—Ni—Mo soft magnetic alloy particle) and the non-magnetic phase (SiO₂ powder) in the magnetic toroidal core.

### 4) Performing a Stress-Relief Annealing

After the soft magnetic composite magnetic toroidal core was molded, a stress-relief annealing was further performed to reduce the hysteresis loss. A high-performance soft magnetic composite was obtained due to the non-uniform distributions of the soft magnetic alloy particle and the non-magnetic phase.

After testing, the sample with the orientation induced by the magnetic field parallel to the working magnetic circuit plane has excellent comprehensive soft magnetic properties.

### EXAMPLE 6

### 1) Preparation of Raw Materials

The spherical Fe—Si—Al soft magnetic alloy particle obtained by a water atomization method was used as the main magnetic phase, and ZnO powder was used as the non-magnetic phase, as the interface phase.

### 2) Coating the Soft Magnetic Alloy Particle with an Insulating Layer

The spherical Fe—Si—Al soft magnetic alloy particle was passivated and then fully mixed with a ZnO powder, forming a mixed powder. The spherical Fe—Si—Al soft magnetic alloy particles were coated with the ZnO powder, forming an insulating layer outside the spherical Fe—Si—Al soft magnetic alloy particle. In the mixed powder, the mass fraction of the spherical Fe—Si—Al soft magnetic alloy particle was 98 wt %, and the mass fraction of the ZnO powder was 2 wt %.

### 3) Molding with an Orientation by Applying a Magnetic Field

The mixed powder obtained in step 2) was loaded into a toroidal mold and subjected to a compression molding to form a magnetic toroidal core, and an electromagnetic magnetic field was applied during the compression molding of the magnetic toroidal core. The magnetic field was parallel to the magnetic toroidal core plane (the working magnetic circuit plane) and perpendicular to the normal direction of the magnetic toroidal core (the normal direction of the working magnetic circuit plane). The magnetic field intensity was 2 T, to re-arrange the main magnetic phase (the spherical Fe—Si—Al soft magnetic alloy particle) and the non-magnetic phase (the ZnO powder) in the magnetic toroidal core.

### 4) Performing a Stress-Relief Annealing

After the soft magnetic composite magnetic toroidal core was molded, a stress-relief annealing was further performed to reduce the hysteresis loss. A high-performance soft magnetic composite was obtained due to the non-uniform distributions of the main magnetic phase (the spherical Fe—Si—Al soft magnetic alloy particle) and the non-magnetic phase (the ZnO powder).

After testing, the sample with the orientation induced by the magnetic field parallel to the working magnetic circuit plane has excellent comprehensive soft magnetic properties.

### EXAMPLE 7

### 1) Preparation of Raw Materials

The spherical Fe-based nanocrystalline soft magnetic alloy particle obtained by a gas atomization method was used as the main magnetic phase, and the interface phase was the non-magnetic phase of TiO₂ powder.

### 2) Coating the Soft Magnetic Alloy Particle with an Insulating Layer

The spherical Fe-based nanocrystalline soft magnetic alloy particle was passivated and then fully mixed with a TiO₂ powder, forming the mixed powder. The spherical Fe-based nanocrystalline soft magnetic alloy particles were coated with TiO₂ powder, forming an insulating layer outside the spherical Fe-based nanocrystalline soft magnetic alloy particle. In the mixed powder, the mass fraction of the spherical Fe-based nanocrystalline soft magnetic alloy particle was 99 wt %, and the mass fraction of the TiO₂ powder was 1 wt %.

### 3) Molding with an Orientation by Applying a Magnetic Field

The mixed powder obtained in step 2) was loaded into a toroidal mold and subjected to a compression molding to form a magnetic toroidal core, and a pulsed magnetic field was applied during the compression molding of the magnetic toroidal core. The magnetic field was parallel to the magnetic toroidal core plane (the working magnetic circuit plane) and perpendicular to the normal direction of the magnetic toroidal core (the normal direction of the working magnetic circuit plane). The magnetic field intensity was 5 T, to re-arrange the main magnetic phase (the spherical Fe-based nanocrystalline soft magnetic alloy particle) and the non-magnetic phase (the TiO₂ powder) in the magnetic toroidal core.

### 4) Performing a Stress-Relief Annealing

After the soft magnetic composite magnetic toroidal core was molded, a stress-relief annealing was further performed to reduce the hysteresis loss, obtaining the high-performance soft magnetic composite with the non-uniform distributions of the main magnetic phase (the spherical Fe-based nanocrystalline soft magnetic alloy particle) and the non-magnetic phase (the TiO₂ powder).

After testing, the sample with the orientation induced by the horizontal magnetic field (parallel to the working magnetic circuit plane) has excellent comprehensive soft magnetic properties.

### EXAMPLE 8

### 1) Preparation of Raw Materials

The spherical Fe—Si—Al soft magnetic alloy particle obtained by a water atomization method was used as the main magnetic phase, and the interface phase is the non-magnetic phase of glass powder.

### 2) Coating the Soft Magnetic Alloy Particle with an Insulating Layer

The spherical Fe—Si—Al soft magnetic alloy particle was passivated and then fully mixed with a glass powder, forming a mixed powder. The spherical Fe—Si—Al soft magnetic alloy particles were coated with the glass powder, forming an insulating layer outside the spherical Fe—Si—Al soft magnetic alloy particle. In the mixed powder, the mass fraction of the spherical Fe—Si—Al soft magnetic alloy particle was 99.9 wt %, and the mass fraction of the glass powder was 0.1 wt %.

### 3) Molding with an Orientation by Applying a Magnetic Field

The mixed powder obtained in step 2) was loaded into a toroidal mold and subjected to a compression molding, and a pulsed magnetic field was applied during the compression molding of the magnetic toroidal core. The magnetic field was parallel to the magnetic toroidal core plane (the working magnetic circuit plane) and perpendicular to the normal direction of the magnetic toroidal core (the normal direction of the working magnetic circuit plane). The magnetic field intensity was 10 T, to re-arrange the main magnetic phase (the spherical Fe—Si—Al soft magnetic alloy particle) and the non-magnetic phase (the glass powder) in the magnetic toroidal core.

### 4) Performing a Stress-Relief Annealing

After the soft magnetic composite magnetic toroidal core was molded, a stress-relief annealing was further performed to reduce the hysteresis loss, obtaining the high-performance soft magnetic composite with the non-uniform distributions of the main magnetic phase (the spherical Fe—Si—Al soft magnetic alloy particle) and the non-magnetic phase.

After testing, the sample with the orientation induced by the magnetic field parallel to the working magnetic circuit plane (i.e. magnetic toroidal core plane) has excellent comprehensive soft magnetic properties.

The above examples are only representative examples of the present disclosure, not used to limit the present disclosure. Various modifications and changes can be made by those skilled in the art. Any modifications, equivalent replacements and improvements made within the spirit and principle of the present disclosure shall fall within the scope of the present disclosure.

What is claimed is:

1. A method for preparing a high-performance soft magnetic composite, comprising:
coating a spherical soft magnetic alloy particle with an insulating layer to form a mixed powder, loading the mixed powder into a mold, and subjecting the mixed powder to a compression molding;
applying an external magnetic field during the compression molding of the mixed powder, wherein the external magnetic field is parallel to a working magnetic circuit plane and perpendicular to a normal direction of the working magnetic circuit plane; and
performing stress-relief annealing to obtain the high-performance soft magnetic composite.

2. The method for preparing a high-performance soft magnetic composite as claimed in claim 1, wherein the external magnetic field has an intensity of about 0.1 to about 10 T.

3. The method for preparing a high-performance soft magnetic composite as claimed in claim 1, wherein the external magnetic field is one selected from the group consisting of a coil magnetic field, an electromagnet magnetic field, and a pulsed magnetic field.

4. The method for preparing a high-performance soft magnetic composite as claimed in claim 1, wherein the external magnetic field is applied in a whole process of the compression molding of the mixed powder.

5. The method for preparing a high-performance soft magnetic composite as claimed in claim 1, wherein a mass fraction of the spherical soft magnetic alloy particle is in the range of about 90 wt % to about 99.9 wt %, and a mass fraction of the insulating layer is in the range of about 0.1 wt % to about 10 wt %.

6. The method for preparing a high-performance soft magnetic composite as claimed in claim 1, wherein the spherical soft magnetic alloy particle is one selected from the group consisting of Fe particle, Fe—Si particle, Fe—Ni particle, Fe—Ni—Mo particle, Fe—Si—Al particle, Fe—Si—B amorphous particle, and Fe-based nanocrystalline particle.

7. The method for preparing a high-performance soft magnetic composite as claimed in claim 1, wherein the insulating layer is one selected from the group consisting of glass powder, sodium silicate, MgO, SiO₂, Al₂O₃, ZnO, and TiO₂.

8. The method for preparing a high-performance soft magnetic composite as claimed in claim 1, wherein the spherical soft magnetic alloy particle has a particle size of about 5 μm to about 40 μm, and a non-magnetic particle has a diameter of about 10 nm to about 200 nm.

9. The method for preparing a high-performance soft magnetic composite as claimed in claim 1, wherein the spherical soft magnetic alloy particle is prepared by a gas atomization method or a water atomization method.

10. A magnetic toroidal core containing the high-performance soft magnetic composite as claimed in claim 1, wherein the magnetic toroidal core comprises a magnetic toroidal core body, wherein the magnetic toroidal core body comprises the spherical soft magnetic alloy particle and a non-magnetic particle coated on the spherical soft magnetic alloy particle;
wherein the non-magnetic particle is distributed at an interface between the spherical soft magnetic alloy particles: the spherical soft magnetic alloy particle is arranged closely and orderly along a direction of a magnetic toroidal core plane, so that the non-magnetic particle is pushed and repelled by the spherical soft magnetic alloy particle to distribute continuously; the spherical soft magnetic alloy particle is arranged disorderly along a normal direction of the magnetic toroidal core, so that the non-magnetic particle is arranged discontinuously;
wherein the anisotropic distributions of the spherical soft magnetic alloy particle and the non-magnetic particle in the magnetic toroidal core cause the anisotropic distributions of the spherical soft magnetic alloy particle and the non-magnetic particle in the magnetic toroidal core.

11. The magnetic toroidal core as claimed in claim 10, wherein the external magnetic field had an intensity of about 0.1 to about 10 T.

12. The magnetic toroidal core as claimed in claim 10, wherein the external magnetic field was one selected from the group consisting of a coil magnetic field, an electromagnet magnetic field, and a pulsed magnetic field.

13. The magnetic toroidal core as claimed in claim 10, wherein the external magnetic field was applied in a whole process of the compression molding of the mixed powder.

14. The magnetic toroidal core as claimed in claim 10, wherein a mass fraction of the spherical soft magnetic alloy particle is in the range of about 90 wt % to about 99.9 wt %, and a mass fraction of the insulating layer is in the range of about 0.1 wt % to about 10 wt %.

15. The magnetic toroidal core as claimed in claim 10, wherein the spherical soft magnetic alloy particle is one selected from the group consisting of Fe particle, Fe—Si particle, Fe—Ni particle, Fe—Ni—Mo particle, Fe—Si—Al particle, Fe—Si—B amorphous particle, and Fe-based nanocrystalline particle.

16. The magnetic toroidal core as claimed in claim 10, wherein the insulating layer is one selected from the group consisting of glass powder, sodium silicate, MgO, SiO₂, Al₂O₃, ZnO, and TiO₂.

17. The magnetic toroidal core as claimed in claim 10, wherein the spherical soft magnetic alloy particle has a particle size of about 5 μm to about 40 μm, and a non-magnetic particle has a diameter of about 10 nm to about 200 nm.

18. The magnetic toroidal core as claimed in claim 10, wherein the spherical soft magnetic alloy particle is prepared by a gas atomization method or a water atomization method.
